(19) United States
(12) Patent Application Publication
(10) Pub. No.: US 2020/0062114 A1
(43) Pub. Date: Feb. 27, 2020

(54) ELECTRIC MOTOR TRANSAXLE WITH SIDE-TO-SIDE TORQUE CONTROL

(71) Applicant: GM Global Technology Operations LLC, Detroit, MI (US)

(72) Inventors: Alan G. Holmes, Clarkston, MI (US); Joseph R. Littlefield, Sterling Heights, MI (US)

(73) Assignee: GM Global Technology Operations LLC, Detroit, MI (US)

(21) Appl. No.: 16/113,416

(22) Filed: Aug. 27, 2018

(51) Int. Cl. B60K 23/04; B60K 1/00; B60K 17/16; F16H 48/10; F16H 48/36; F16H 48/05

(52) U.S. Cl. CPC B60K 23/04; B60K 1/00; B60K 17/165; F16H 48/10; F16H 2048/104; F16H 48/05; B60K 2001/001; B60K 2023/043; F16H 48/36

(57) ABSTRACT

An electric motor transaxle having a transaxle housing for a vehicle drive axle includes first and second axle-shafts that are configured to rotate about a common first axis. The transaxle includes a first planetary gear-set operatively connected to the first axle-shaft, configured to rotate about the first axis, and having first, second, third, and fourth members. The transaxle additionally includes a second planetary gear-set operatively connected to the second axle-shaft, configured to rotate about the first axis, and having first, second, third, and fourth members. The transaxle further includes an electric motor arranged on the first axis and configured to provide a direct electric motor torque input to each of the first and second planetary gear-sets. A vehicle drive axle for mounting in a motor vehicle and employing such an electric motor transaxle is also disclosed.

### INTRODUCTION

The disclosure relates to an electric motor transaxle and differential with side-to-side torque control for a motor vehicle.

Modern motor vehicles are typically configured as either two- or all-wheel-drive. Either type of a vehicle may employ a conventional powertrain, where a single engine is used to propel the vehicle, an electric powertrain, where an electric motor is used to propel the vehicle, or a hybrid powertrain, where two or more distinct power sources, such as an internal combustion engine and an electric motor, are used to accomplish the same task.

An all-wheel-drive hybrid vehicle may be configured as an axle-split vehicle. In such a vehicle, independent power-sources, such as an internal combustion engine and an electric motor, are set up to independently power individual vehicle axles that are operatively connected to the respective power-sources, thus generating on-demand all-wheel-drive propulsion. In such an axle-split hybrid vehicle employing an engine and an electric motor, the electric motor may be capable of propelling the vehicle via the respective axle while the engine is shut off.

Each powered axle typically includes a final drive assembly with a differential that allows opposite side, i.e., left and right side, driven wheels to rotate at different speeds when the vehicle negotiates a turn. Specifically, the differential permits the driven wheel that is traveling around the outside of the turning curve to roll farther and faster than the driven wheel traveling around the inside of the turning curve, while approximately equal torque is applied to each of the driven wheels. An increase in the speed of one driven wheel is balanced by a decrease in the speed of the other driven wheel, while the average speed of the two driven wheels equals the input rotational speed of the drive shaft connecting the power-source to the differential.

### SUMMARY

An electric motor transaxle having a transaxle housing for a vehicle drive axle including first and second axle-shafts that are configured to rotate about a common first axis. The electric motor transaxle includes a first planetary gear-set operatively connected to the first axle-shaft, configured to rotate about the first axis, and having first, second, third, and fourth members. The electric motor transaxle additionally includes a second planetary gear-set operatively connected to the second axle-shaft, configured to rotate about the first axis, and having first, second, third, and fourth members. The electric motor transaxle further includes an electric motor arranged on the first axis and configured to provide a direct electric motor torque input to each of the first and second planetary gear-sets.

The electric motor may include a stator and rotor. In such an embodiment, the stator may be fixed to the transaxle housing and the rotor may be operatively connected to each of the first and second planetary gear-sets.

Each of the fourth member of the first planetary gear-set and the fourth member of the second planetary gear-set may be directly connected to the rotor of the electric motor.

The electric motor transaxle may additionally include a transfer shaft arranged on a second axis that is parallel to the first axis and configured to operatively connect the first planetary gear-set to the second planetary gear-set.

The electric motor transaxle may also include an idler gear arranged between the transfer shaft and the second planetary gear-set. The idler gear may be configured to reverse a direction of rotation of the first planetary gear-set relative to a direction of rotation of the second planetary gear-set.

The electric motor transaxle may additionally include a clutch arranged on the transfer shaft and configured to selectively disconnect the first planetary gear-set from the second planetary gear-set. A specific embodiment of such a clutch may be a selectable one-way clutch.

In each of the first and second planetary gear-sets, the respective first member may be a relatively smaller diameter ring gear and the respective second member may be a relatively larger diameter ring gear, the respective third member may be a planetary carrier, and the respective fourth member may be a sun gear.

The first planetary gear-set may include a first set of stepped diameter pinion gears and the second planetary gear-set may include a second set of stepped diameter pinion gears. In such an embodiment, each stepped diameter pinion gear of the first and second sets of stepped diameter pinion gears may include a relatively smaller diameter pinion gear portion and a relatively larger diameter pinion gear portion. Additionally, in each of the first and second planetary gear-sets, the relatively smaller diameter pinion gear portion may be in mesh with the relatively smaller diameter ring gear and the relatively larger diameter pinion gear portion may be in mesh with the relatively larger diameter ring gear.

The electric motor transaxle may also include a first brake configured to ground one of the relatively larger diameter ring gear and the relatively smaller ring gear of the first planetary gear-set to the transaxle housing, and additionally a second brake configured to ground one of the relatively larger diameter ring gear and the relatively smaller ring gear of the second planetary gear-set to the transaxle housing.

The planetary carrier of the first planetary gear-set may be continuously connected to the first axle-shaft and the planetary carrier of the second planetary gear-set may be continuously connected to the second axle-shaft.

A vehicle drive axle for being mounted in a motor vehicle and employing such an electric motor transaxle is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a vehicle employing a hybrid electric powertrain that includes an internal combustion engine operatively connected to a first axle and a second axle employing an electric motor transaxle incorporating an electric motor, according to the disclosure.

FIG. 2 is a schematic close-up cross-sectional plan view of one embodiment of the electric motor transaxle shown in FIG. 1.

FIG. 3 is a schematic close-up cross-sectional plan view of another embodiment of the electric motor transaxle shown in FIG. 1.

### DETAILED DESCRIPTION

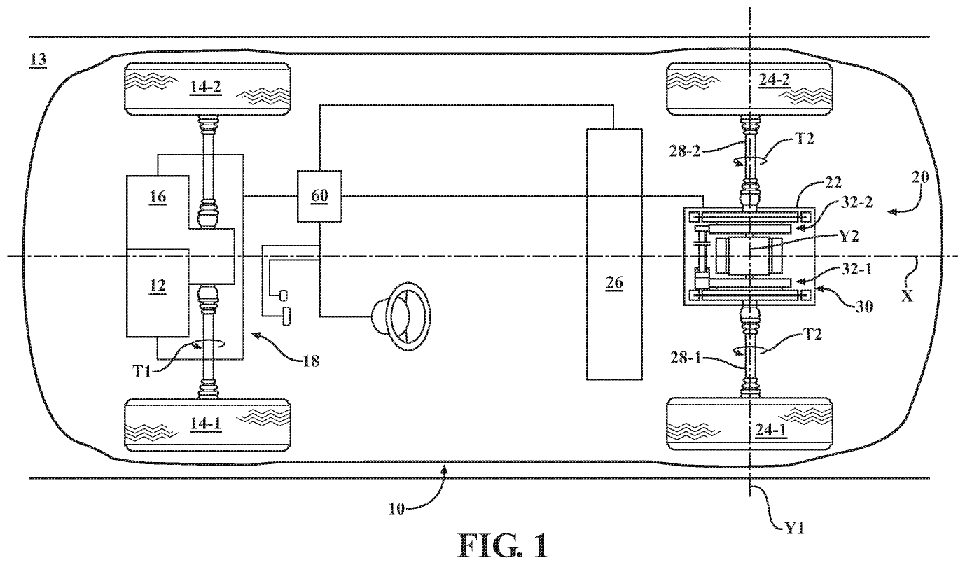

Referring to the drawings in which like elements are identified with identical numerals throughout, FIG. 1 illustrates a vehicle 10 that uses an electric motor, to be discussed in greater detail below, to drive a pair of opposite, a left and a right, side wheels. As shown, the vehicle 10 is a hybrid vehicle having independent first and second power-sources that are operatively connected to respective sets of driven wheels in order to provide on-demand all-wheel-drive propulsion. The vehicle 10 may be, but is not be limited to, a commercial vehicle, industrial vehicle, passenger vehicle, train or the like. As shown, the vehicle 10 is generally arranged along a longitudinal vehicle axis X. The vehicle 10 includes a first power-source shown as an internal combustion engine 12 configured to drive the vehicle via a first set of wheels, which includes a first or left-side wheel 14-1 and a second or right-side wheel 14-2, for transmitting engine output or drive torque T1 to a road surface 13 through a transmission assembly 16 and a first axle 18.

The vehicle 10 additionally includes a second axle 20. As shown, the second axle 20 is operatively independent from the engine 12 and the transmission 16. The second axle 20 includes an electric motor-generator 22 that is configured to drive the vehicle 10 via a second set of wheels, which includes a first or left-side road wheel 24-1 and a second or right-side road wheel 24-2. The electric motor-generator 22 receives its electrical energy from an energy storage device 26. As understood by those skilled in the art, the motor-generator 22 includes a stator 22-1 and a rotor 22-2 configured to impart a motor-generator output or drive torque T2. According to the present disclosure, the electric motor-generator 22 is configured to drive the vehicle 10 via the drive torque T2 independently from the engine 12 and provides the vehicle 10 with an on-demand electric axle drive. The vehicle 10 may be driven solely via the electric motor-generator 22, i.e., in a purely electric vehicle or “EV” mode. On the other hand, when both first and second axles 18, 20 are driven by the respective engine 12 and the electric motor-generator 22, the vehicle 10 is endowed with all-wheel-drive. Although the remaining disclosure will focus primarily on the description of the second axle 20, it should be noted, however, that there is nothing to stop the vehicle 10 from including a second electric motor-generator. Such an additional motor-generator may be substantially similar to the electric motor-generator 22 and be included as part of the first axle 18 for supplying drive torque T1 to the front wheels 14-1, 14-2, whether in addition to the internal combustion engine 12 or in the absence thereof. Accordingly, in the embodiment of the vehicle 10 which excludes the internal combustion engine 12, the vehicle 10 is an electric propulsion vehicle.

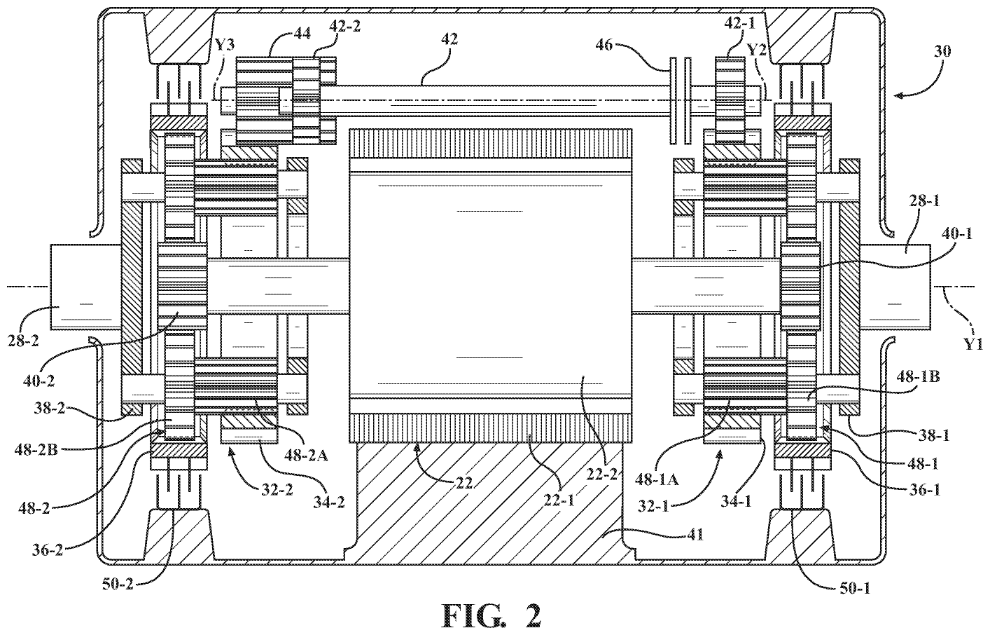

The second axle 20 includes a first axle-shaft 28-1 operatively connected to the left-side road wheel 24-1 and a second axle-shaft 28-2 operatively connected to the left-side road wheel 24-2. Each of the first and second axle-shafts 28-1, 28-2 is configured to rotate about a common first axis Y1. As may be seen, the first axis Y1 is arranged generally perpendicular to the longitudinal vehicle axis X. The second axle 20 also includes an electric motor transaxle 30 configured to transmit the drive torque T2 to the first and second axle-shafts 28-1, 28-2. As shown in FIG. 2, the electric motor transaxle 30 includes a first gear-set 32-1 operatively connected to the first axle-shaft 28-1. The electric motor transaxle 30 additionally includes a second gear-set 32-2 operatively connected to the second axle-shaft 28-2. As shown, the first planetary gear-set 32-1 is a planetary or epicyclic gear-set configured to rotate about the first axis Y1 and has a first member 34-1, a second member 36-1, a third member 38-1, and a fourth member 40-1. The second planetary gear-set 32-21 is a planetary gear-set similarly configured to rotate about the first axis Y1 and has a first member 34-2, a second member 36-2, a third member 38-2, and a fourth member 40-2.

The motor-generator 22 is arranged on the first axis Y1 between the first and second gear-sets 32-1, 32-2. The motor-generator 22, being part of the electric motor transaxle 30 is configured to apply the drive torque T2 input directly, i.e., provide direct torque input, to each of the first and second gear-sets 32-1, 32-2. As shown, the electric motor transaxle 30 generally includes a transaxle case or housing 41 configured to enclose various components disclosed and described herein. The stator 22-1 of the motor-generator 22 may be fixed to the transaxle housing 41. The rotor 22-2 of the motor-generator 22 is operatively connected to each of the first and second planetary gear-sets 32-1, 32-2. Specifically, each of the fourth member 40-1 of the first planetary gear-set 32-1 and the fourth member 40-2 of the second planetary gear-set 32-2 may be directly connected to the rotor 22-2. Furthermore, the third member 38-1 of the first planetary gear-set 32-1 may be continuously connected, i.e., for simultaneous rotation without interruption of the connection or the resultant transmission of torque, to the first axle-shaft 28-1, while the third member 38-2 of the second planetary gear-set 32-2 may be continuously connected to the second axle-shaft 28-2.

With continued reference to FIG. 2, the electric motor transaxle 30 may also include a transfer shaft 42 arranged on a second axis Y2 that is parallel to the first axis Y1. The transfer shaft 42 is configured to operatively, i.e., rotationally, connect the first planetary gear-set 32-1 to the second planetary gear-set 32-2. The electric motor transaxle 30 may additionally include an idler gear 44 arranged between the transfer shaft 42 and the second planetary gear-set 32-2. The idler gear 44 is configured to rotate about a third axis Y3 that is parallel to each of the first and second axes Y1, Y2. As shown in FIG. 2, the idler gear 44 is in continuous meshing engagement with the first member 34-2 of the second planetary gear-set 32-2. The idler gear 44 is configured to reverse a direction of rotation of the first member 34-2 of the second planetary gear-set 32-2 relative to a direction of rotation of the first member of 34-1 the first planetary gear-set 32-1. As shown, the transfer shaft 42 specifically includes a first splined end 42-1 in mesh with the first member 34-1 of the first planetary gear-set 32-1 and a second splined end 42-2 operatively connected to the first member 34-2 of the second planetary gear-set 32-2 via the idler gear 44.

The electric motor transaxle 30 may further include a clutch 46 arranged on and incorporated into the transfer shaft 42 (shown in FIG. 2) and configured to selectively disconnect the first planetary gear-set 32-1 from the second planetary gear-set 32-2. The clutch 46 may be configured as a selectable one-way clutch (OWC). Specifically, the clutch 46 may disconnect the first splined end 42-1 from the second splined end 42-2 and permit the two respective splined ends to rotate independently of one another. With continued reference to FIG. 2, in the first planetary gear-set 32-1, the respective first member 34-1 may be a relatively smaller diameter ring gear and the second member 36-1 may be a relatively larger diameter ring gear. Similarly, in the second planetary gear-set 32-2, the respective first member 34-2 may be a relatively smaller diameter ring gear and the second member 36-2 may be a relatively larger diameter ring gear. Each of the respective third members 38-1, 38-2 may be a planetary carrier, while each of the respective fourth members 40-1, 40-2 may be a sun gear. Each respective planetary carrier embodiment of the third members 38-1, 38-2 is intended to support a plurality of pinion gears 48-1, 48-2, respectively. As shown, the pinion gears 48-1 are in mesh with the respective first members 34-1, second members 36-1, and fourth member 40-1. Similarly, the pinion gears 48-2 are in mesh with the respective first members 34-2, second members 36-2, and fourth member 40-2.

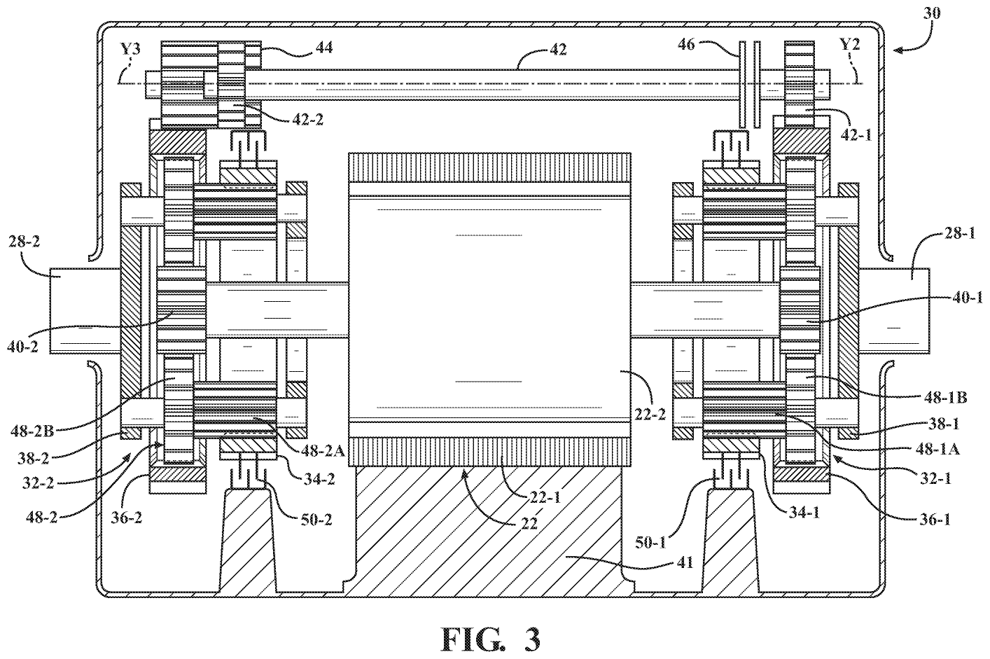

As shown in FIGS. 2 and 3, the plurality of pinion gears 48-1 may be configured as a respective first set of stepped diameter pinion gears rotatably mounted on the planetary carrier 38-1 of the first planetary gear-set 32-1. Similarly, the plurality of pinion gears 48-2 may be configured as a respective second set of stepped diameter pinion gears rotatably mounted on the planetary carrier 38-2 of the second planetary gear-set 32-2. Each the first and second planetary gear-sets 32-1 and 32-2 may include at least three respective stepped diameter pinion gears 48-1, 48-2. Each stepped diameter pinion gear 48-1 may include a relatively smaller diameter pinion gear portion 48-1A and a relatively larger diameter pinion gear portion 48-1B. Similarly, each stepped diameter pinion gear 48-2 may include a relatively smaller diameter pinion gear portion 48-2A and a relatively larger diameter pinion gear portion 48-2B. In the described embodiment, each relatively smaller diameter pinion gear portion 48-1A, 48-2A is in mesh with the respective relatively smaller diameter ring gear 34-1, 34-2. Furthermore, each relatively larger diameter pinion gear portion 48-1B, 48-2B is in mesh with the respective relatively larger diameter ring gear 36-1, 36-2.

The electric motor transaxle 30 may also include a first brake 50-1 and a second brake 50-2. In an embodiment shown in FIG. 2, the first brake 50-1 is configured to ground the relatively larger diameter ring gear 36-1 of the first planetary gear-set 32-1 to the transaxle housing 41. Furthermore, as shown in the embodiment of FIG. 2, the second brake 50-2 is configured to ground the relatively larger diameter ring gear 36-2 of the second planetary gear-set 32-2 to the transaxle housing 41. In an alternative embodiment shown in FIG. 3, the first brake 50-1 is configured to ground the relatively smaller ring gear 34-1 of the first planetary gear-set 32-1 to the transaxle housing 41. In the same embodiment, the second brake 50-2 is configured to ground the relatively smaller diameter ring gear 34-2 of the second planetary gear-set 32-2 to the transaxle housing 41. In either of the embodiments shown in FIGS. 2 and 3, the electric motor transaxle 30 utilizes differential rotation of a member of each of the first and second gear-sets 32-1, 32-2 as regulated by controlled application of the first and second brakes 50-1, 50-2. Overall, such controlled application of the first and second brakes 50-1, 50-2 is intended to permit the first and second axle-shafts 28-1, 28-2 to rotate at different speeds, while each of the first and second gear-sets receives the drive torque T2, as the vehicle traverses the road surface 13.

As shown in FIG. 1, the vehicle 10 also includes a programmable controller 60 configured to achieve desired propulsion of the vehicle 10 in response to command(s) from an operator of the subject vehicle. Specifically, the controller 60 may be programmed to regulate and coordinate operation of the first power-source, such as the internal combustion engine 12, and the electric motor transaxle 30. Accordingly, the controller 60 may control the operation of the motor-generator 22, as well as the first and second brakes 50-1, 50-2. The first and second brakes 50-1, 50-2 may be regulated by modulating the amount of pressure applied to the respective brakes, and thereby permit controlled brake slip and unsynchronized rotation of the respective road wheels 24-1, 24-2, while appropriately transmitting drive torque T2 to the first and second road wheels 24-1, 24-2. The controller 60 may also be programmed to control operation of the clutch 46 to selectively disconnect the gear-set 32-1 from the second gear-set 32-2 and permit the respective first and second axle-shafts 28-1, 28-2 to rotate entirely independently of one another. In such a situation, while the first and second axle-shafts 28-1, 28-2 would rotate independently, each of the first and second axle-shafts would individually transmit the drive torque T2 to the respective first and second road wheels 24-1, 24-2. To accomplish the above, the controller 60 may include a processor and tangible, non-transitory memory, which includes instructions for operation of the electric motor transaxle 30 programmed therein. The memory may be any recordable medium that participates in providing computer-readable data or process instructions. Such a recordable medium may take many forms, including but not limited to non-volatile media and volatile media.

Non-volatile media for the controller 60 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 60 may also include a floppy disk, a flexible disk, hard disk, magnetic tape, any other magnetic medium, a CD-ROM, DVD, any other optical medium, etc. The controller 60 may be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the controller 60 or accessible thereby may be stored in the memory and automatically executed to provide the required functionality of the electric motor transaxle 30.

In operation, the controller 60 may fully engage or close the first brake 50-1 and thereby cause the first road wheel 24-1 to rotate faster than the second road wheel 24-2, or alternatively close the second brake 50-2 and thereby cause the second road wheel 24-2 to rotate faster than the first road wheel 24-1. Furthermore, the controller 60 may be programmed to partially engage or slip one of the first brake 50-1 and the second brake 50-2 to urge one of the first road wheel 24-1 and the second road wheel 24-2 to rotate faster than other. Such disparate rotation speeds of the first and second road wheels 24-1, 24-2, will facilitate differential action in the electric motor transaxle 30, for example, for negotiating turns. Additionally, such capability of the electric motor transaxle 30 may be used to facilitate a torque vectoring or yaw control function in the vehicle, i.e., ability to vary the input torque to each wheel 24-1, 24-2 for influencing turn-in and handling of the vehicle 10.

In the embodiment of FIG. 3, the controller 60 may engage the clutch 46 to affect a numerically lower gear ratio in the electric motor transaxle 30. Additionally, partially engaging the first and second brakes 50-1, 50-2 via the controller 60, to permit relative slip between respective first and second brakes, while disengaging the clutch 46, may be used to affect a numerically higher gear ratio in the electric motor transaxle 30. In the alternative embodiment of FIG. 2, the controller 60 may be configured to partially engage the first and second brakes 50-1, 50-2 to permit relative slip between respective first and second brakes, while disengaging the clutch 46 to affect a numerically lower gear ratio in the electric motor transaxle 30. Additionally, fully engaging the clutch 46 may be used to affect a numerically higher gear ratio in the electric motor transaxle 30. In either of the two above-described embodiments, the electric motor transaxle 30 is configured to enable differential action between the first and second axle-shafts 28-1, 28-2, while selectively providing two distinct gear ratios between the motor-generator 22 and the road wheels 24-1, 24-2.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electric motor transaxle having a transaxle housing for a vehicle drive axle having first and second axle-shafts that are configured to rotate about a common first axis, the electric motor transaxle comprising:
a first planetary gear-set operatively connected to the first axle-shaft, configured to rotate about the first axis, and having first, second, third, and fourth members;
a second planetary gear-set operatively connected to the second axle-shaft, configured to rotate about the first axis, and having first, second, third, and fourth members; and
an electric motor arranged on the first axis and configured to provide a direct electric motor torque input to each of the first and second planetary gear-sets.

2. The electric motor transaxle according to claim 1, wherein the electric motor includes a stator fixed to the transaxle housing and a rotor operatively connected to each of the first and second planetary gear-sets, and wherein each of the fourth member of the first planetary gear-set and the fourth member of the second planetary gear-set is directly connected to the rotor of the electric motor.

3. The electric motor transaxle according to claim 1, further comprising a transfer shaft arranged on a second axis that is parallel to the first axis and configured to operatively connect the first planetary gear-set to the second planetary gear-set.

4. The electric motor transaxle according to claim 3, further comprising an idler gear arranged between the transfer shaft and the second planetary gear-set and configured to reverse a direction of rotation of the first planetary gear-set relative to a direction of rotation of the second planetary gear-set.

5. The electric motor transaxle according to claim 3, further comprising a clutch arranged on the transfer shaft and configured to selectively disconnect the first planetary gear-set from the second planetary gear-set.

6. The electric motor transaxle according to claim 5, wherein the clutch is configured as a selectable one-way clutch.

7. The electric motor transaxle according to claim 1, wherein, in each of the first and second planetary gear-sets, the respective first member is a relatively smaller diameter ring gear, the second member is a relatively larger diameter ring gear, the respective third member is a planetary carrier, and the respective fourth member is a sun gear.

8. The electric motor transaxle according to claim 7, wherein:
the first planetary gear-set includes a first set of stepped diameter pinion gears;
the second planetary gear-set includes a second set of stepped diameter pinion gears;
each stepped diameter pinion gear of the first and second sets of stepped diameter pinion gears includes a relatively smaller diameter pinion gear portion and a relatively larger diameter pinion gear portion; and
in each of the first and second planetary gear-sets, the relatively smaller diameter pinion gear portion is in mesh with the relatively smaller diameter ring gear and the relatively larger diameter pinion gear portion is in mesh with the relatively larger diameter ring gear.

9. The electric motor transaxle according to claim 7, further comprising:
a first brake configured to ground one of the relatively larger diameter ring gear and the relatively smaller ring gear of the first planetary gear-set to the transaxle housing; and
a second brake configured to ground one of the relatively larger diameter ring gear and the relatively smaller ring gear of the second planetary gear-set to the transaxle housing.

10. The electric motor transaxle according to claim 7, wherein the planetary carrier of the first planetary gear-set is continuously connected to the first axle-shaft and the planetary carrier of the second planetary gear-set is continuously connected to the second axle-shaft.

11. A vehicle drive axle comprising:
a first road wheel and a second road wheel;
a first axle-shaft operatively connected to the first road wheel and a second axle-shaft operatively connected to the second road wheel, wherein each of the first and second axle-shafts is configured to rotate about a common first axis; and
an electric motor transaxle having a transaxle housing and configured to transmit a drive torque to the first and second axle-shafts, the electric motor transaxle including:
a first planetary gear-set operatively connected to the first axle-shaft, configured to rotate about the first axis, and having first, second, third, and fourth members;
a second planetary gear-set operatively connected to the second axle-shaft, configured to rotate about the first axis, and having first, second, third, and fourth members; and
an electric motor arranged on the first axis and configured to provide a direct electric motor torque input to each of the first and second planetary gear-sets.

12. The vehicle drive axle according to claim 11, wherein the electric motor includes a stator fixed to the transaxle housing and a rotor operatively connected to each of the first and second planetary gear-sets, and wherein each of the fourth member of the first planetary gear-set and the fourth member of the second planetary gear-set is directly connected to the rotor of the electric motor.

13. The vehicle drive axle according to claim 11, wherein the electric motor transaxle further includes a transfer shaft arranged on a second axis that is parallel to the first axis and configured to operatively connect the first planetary gear-set to the second planetary gear-set.

14. The vehicle drive axle according to claim 13, wherein the electric motor transaxle further includes an idler gear arranged between the transfer shaft and the second planetary gear-set and configured to reverse a direction of rotation of the first planetary gear-set relative to a direction of rotation of the second planetary gear-set.

15. The vehicle drive axle according to claim 13, wherein the electric motor transaxle further includes a clutch arranged on the transfer shaft and configured to selectively disconnect the first planetary gear-set from the second planetary gear-set.

16. The vehicle drive axle according to claim 15, wherein the clutch is configured as a selectable one-way clutch.

17. The vehicle drive axle according to claim 11, wherein, in each of the first and second planetary gear-sets, the respective first member is a relatively smaller diameter ring gear, the second member is a relatively larger diameter ring gear, the respective third member is a planetary carrier, and the respective fourth member is a sun gear.

18. The vehicle drive axle according to claim 17, wherein:
the first planetary gear-set includes a first set of stepped diameter pinion gears;
the second planetary gear-set includes a second set of stepped diameter pinion gears;
each stepped diameter pinion gear of the first and second sets of stepped diameter pinion gears includes a relatively smaller diameter pinion gear portion and a relatively larger diameter pinion gear portion; and
in each of the first and second planetary gear-sets, the relatively smaller diameter pinion gear portion is in mesh with the relatively smaller diameter ring gear and the relatively larger diameter pinion gear portion is in mesh with the relatively larger diameter ring gear.

19. The vehicle drive axle according to claim 17, wherein the electric motor transaxle further includes:
a first brake configured to ground one of the relatively larger diameter ring gear and the relatively smaller ring gear of the first planetary gear-set to the transaxle housing; and
a second brake configured to ground one of the relatively larger diameter ring gear and the relatively smaller ring gear of the second planetary gear-set to the transaxle housing.

20. The vehicle drive axle according to claim 17, wherein the planetary carrier of the first planetary gear-set is continuously connected to the first axle-shaft and the planetary carrier of the second planetary gear-set is continuously connected to the second axle-shaft.
